(19) United States
(12) Patent Application Publication
(10) Pub. No.: US 2008/0023124 A1
(43) Pub. Date: Jan. 31, 2008

(54) Process for Manufacturing a Tyre Comprising the Step of Marking a Structural Element Thereof

(76) Inventors: Claudio Lacagnina, Milano (IT); Filippo Magnani, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/581,093

(22) PCT Filed: Dec. 12, 2003
(86) PCT No.: PCT/EP03/14119

§ 371 Date: Mar. 22, 2007

(51) Int. Cl. B29D 30/06

(52) U.S. Cl. 156/130.5

(57) ABSTRACT

A process for manufacturing a tyre includes the following steps: a) providing a carcass structure; b) providing one structural element of the tyre by laying down at least one elongate element of the tyre by laying down at least one elongate element made of crude elastomer material in a position radially external to the carcass structure; c) providing the structural element of the green tyre with one marking by means of an inkjet marking device; d) introducing the green tyre into a moulding cavity; and f) curing the green tyre.

The present invention relates to a process for manufacturing a tyre.

In particular, the present invention relates to a process for manufacturing a tyre which comprises the step of providing a structural element of the tyre with at least one marking by means of an ink printing device.

More in particular, the present invention relates to a process for manufacturing a tyre which comprises the step of providing the tyre tread band, or the tyre sidewalls or both with at least one marking by means of an ink printing device.

In tyre manufacturing processes it is common practice to provide the tyre tread band or the tyre sidewalls with a printed marking.

In particular, it is common practice to provide the tyre tread band with printed indicia which allow the tyre manufacturer or the car manufacturer to precisely identify a tyre and to avoid that different tyres can be mistaken one for another. For instance, alpha-numeric identification codes are generally provided to the tyre tread band outer surface, said codes containing relevant information on the tyre, e.g. the size thereof.

A correct and unambiguous identification of a tyre is a very important aspect during the manufacturing process thereof since tyres, which may appear to be identical, can be provided with different or even very different internal structures, thus requiring, for instance, different curing cycles to be carried out.

Therefore, the presence of identification codes guarantees that the operator—or a predetermined robotized apparatus—correctly performs, on a given tyre, specific working operations (e.g. a curing cycle lasting a predetermined curing time) which are designed for said tyre.

In conventional manufacturing processes, the tyre structural (i.e. constitutive) elements—e.g. the carcass structure, the belt structure, the tread band—are made by using semi-finished products, i.e. continuous sheets of elastomeric material—possibly in combination with reinforcing elements such as steel or textile cords—that are prepared separately and in large quantities previously to the tyre assembling operations.

According to said conventional processes, for each tyre component, the manufacturing process comprises the steps of winding a predetermined elastomeric sheet onto a building drum, cutting (or in some cases pre-cutting) said sheet into a length approximately equal to the circumference of the drum, and joining the circumferentially opposite ends of said sheet length directly on the building drum.

In more recent times particular attention has been given to production methods that would eliminate or at least remarkably reduce the preliminary production of said semi-finished products. For example, the European patent EP-928,680—in the name of the same Applicant—discloses the manufacturing of a green tyre by consecutively producing and assembling together on a toroidal support the tyre structural elements. In details, the tyre is manufactured by axially overlapping and/or radially superimposing turns of a strip-like element on the toroidal support, said strip-like element being a strip of an elastomeric material only, or a strip of elastomeric material embedding reinforcing elements thereinto, typically textile or metal cords, or a rubberized metal wire or cord.

According to said further process, the toroidal support is moved, preferably by a robotized system, between a plurality of work stations in each of which, through automated sequences, a particular building step of the tyre is carried out.

The manufacturing process further comprises the successive step of moulding the green tyre, so as to confer to the latter a desired tread pattern, and the step of curing the green tyre, so as to confer to the latter a desired geometrical conformation which is obtained by curing the elastomer material forming the tyre itself.

The moulding and curing steps of the green tyre are carried out by introducing the green tyre into a moulding cavity defined within a vulcanization mould, whose shape matches the shape of the outer surface of the tyre to be obtained, and by introducing a fluid under pressure into a diffusion interspace (or diffusion gap) provided between the inner circumferential surface of the green tyre and the toroidal support.

Such a tyre manufacturing process is described, for instance, in the European Patent EP-976,533 in the name of the same Applicant, according to which, during the pressing of the raw elastomer material against the walls of the moulding cavity, a radial expansion is imposed to the tyre by effect of a pressurized-fluid introduction. The pressurized-fluid introduction is preferably carried out by means of feeding channels formed in the toroidal support and terminating at the outer surface of the latter. During the pressurized-fluid introduction, the tyre is sealingly engaged at its circumferential inner edges, between the walls of the moulding cavity and the outer surface of the toroidal support, so as to delimit the diffusion interspace at the circumferential inner edges of the tyre itself. Advantageously, the heat amount which is necessary for curing the green tyre is provided to the latter through the walls of the moulding cavity and by means of a heating fluid which is introduced into the diffusion interspace. Preferably said heating fluid is the fluid under pressure used for carrying out the pressing step or is at least part of said fluid under pressure.

The tyre manufacturing process disclosed in the European Patent EP-928,680 mentioned above allows that tyres with different sizes and/or different internal structures (e.g. different number of carcass or belt plies, presence of elastomeric or reinforced inserts in specific regions of the tyre structure) can be manufactured simultaneously in the same plant thanks to a suitable electronic control of the work stations—which operate consecutively according to a predetermined sequence—and to the great production flexibility of the same.

Therefore, since such a plant configuration is able to simultaneously carry out the manufacturing of different tyres, it is necessary that, at the end of the assembling operations, the green tyre, in particular the tread band thereof, is provided with printed indicia so that mistakes in the successive moulding and curing steps can be advantageously avoided.

Furthermore, the identification codes are generally used also in the final checking of the tyre wherein, in order to verify the quality of the finished cured tyre, an operator needs to precisely identify the tyre to allow that a plurality of tests—e.g. the tyre uniformity test—can be correctly set up and performed.

Moreover, the identification codes provided to a tyre are generally used also by the tyre delivering centres as a means for suitably storing them and, successively, for correctly performing the delivering of the same.

Further to the alpha-numeric identification codes mentioned above, a tyre tread band is frequently requested to be provided also with circumferential lines (which are generally identified by the technicians as WDK lines), the colour and the position of which being used by the car manufacturers to unambiguously identify a tyre. For instance, said circumferential lines are used to indicate the tyre size (e.g. the ratio between the nominal section height and the nominal section width), the tyre speed category, the presence of an inner bladder (i.e. to indicate if a tyre is of the tubeless type).

Among the known techniques available in the art, the marking of a tyre can be carried out by using a printing device which comes into contact with the tyre surface and transfers thereon a predetermined identification code. For instance, such a printing device can comprise a wheel having a plurality of arms, each arm being provided with a given character to be imprinted on the tyre surface. During the wheel rotation, each arm is caused to pick up some ink from an ink vessel so that the character supported on the arm is impregnated with the ink and, successively, the wheel rotating movement causes the impregnated character to contact the tyre surface so that the imprinting of the code is performed.

Document U.S. Pat. No. 4,134,362 discloses an apparatus for applying fluid colouring material to a tyre sidewall, said apparatus comprising a holder that is provided with an applicator movable towards and away from the tyre sidewall. The applicator comprises an applicator wheel which is resiliently urged against the tyre sidewall and applies the fluid colouring material thereto from the gravity fed applicator.

Further marking devices are known which make use of ink-jetting apparatuses.

For instance, document GB-2,370,546 discloses the use of an ink-jetting device which acts on a moulded and cured tyre for providing the tread band thereof with a wear indicator. In details, said document discloses a marking device which comprises a probe for inserting into a channel of a tyre tread (i.e. into a groove of the tyre tread band), and a marking head directed from a side of the probe for marking a side of the tyre tread channel. In use the probe is inserted into a selected tyre tread channel to rest against the bottom surface of the channel, then the device is moved along the tyre tread channel to mark the side of the channel. According to said document the marking head comprises an inking head, preferably an ink spraying head.

Document JP 2001-149830 discloses a marking apparatus for marking colour lines on tyre treads. The apparatus comprises tanks for containing different colours and a tank for containing a cleaning liquid (i.e. a solvent), the nozzles ejecting the different colours being cleaned with said cleaning liquid after each colour is coated on the tread of the tyre. Said document discloses and shows the application of different colour lines onto a tread running in a longitudinal direction, said tread being represented to move on a plurality of supporting rolls during the formation of the coloured lines.

The Applicant has perceived that some problems may arise in marking a structural element of a green tyre which was obtained by laying down at least one continuous elongate element made of crude elastomer material in a position radially external to the tyre carcass structure.

According to such a tyre manufacturing process, as disclosed, for instance, in the European Patent EP-928,680 mentioned above, a tyre structural element can be obtained by winding at least one elongate (strip-like) element of elastomer material in circumferentially coils axially contiguous to each other, e.g. in case a tread band or the tyre sidewalls are going to be manufactured.

The Applicant has observed that, in the above manufacturing process, if the marking of the tyre structural element is carried out by imprinting according to conventional techniques, the presence of the windings of the elongate element may cause some problems.

As a matter of fact, disuniformities of the outer surface of the structural element are caused by the partial overlapping of the adjacent windings of the elongate element. Said disuniformities are present only on the green tyre and do not negatively affect the quality of the finished tyre since they substantially disappear during the tyre moulding and curing steps.

The Applicant has perceived that the step of providing the structural element with at least one marking has to be carried out by avoiding any direct contact of the marking device with the windings of the elongate element which form the tyre structural element, since any pressure applied thereon—e.g. that exerted by an applicator wheel—may cause a deformation of the elongate element, and therefore an undesired modification of the outer profile of the structural element, which may negatively affect the quality of the finished tyre.

Moreover, the Applicant has perceived that, by pressing and directly contacting an applicator onto the outer surface of a tyre structural element obtained by assembling at least one elongate element of crude rubber, the pressing action of the applicator and the subsequent deformation of the elongate element may cause the ink—which impregnates the applicator—to penetrate under the overlapping portions of adjacent windings. This may be particularly disadvantageous since the penetration of ink beneath adjacent windings (coils) of the elongate element can cause a poor adhesion of said windings which are made from uncured elastomeric material. As a consequence of poor adhesion among adjacent windings, possible defects may occur in the finished tyre, such as disuniformity of the tyre tread band.

Furthermore, the presence of noticeable amounts of ink trapped between the windings of the elongate element may cause problems in the further steps of the tyre manufacturing process. For instance, defects may originate in the curing step of the green tyre, such as the formation of swellings and/or detachments of the tread band from the adjacent constitutive elements of the tyre, thus causing the finished tyre to be discarded.

Moreover, the Applicant has observed that, by marking a structural element of the tyre which is formed by windings of an elongate element by means of a conventional contacting applicator, the quality of the marking is unsatisfactory in terms of readability. The latter is in fact negatively affected both by the irregular outer surface of the structural element, due to the overlapping of adjacent elongate elements, and by the partial penetration and thus disappearance of the ink beneath the overlapped portions.

The Applicant has found that, in tyre manufacturing processes wherein a structural element of the tyre is produced and assembled directly onto the tyre carcass structure by laying down at least one elongate element made of crude elastomer material, the marking of said structural element can be advantageously carried out by using an inkjet marking device.

In particular, the Applicant has found that the marking of a tyre structural element by ink spraying can be carried out in tyre manufacturing processes according to which the green tyre is obtained by consecutively producing and assembling together on a toroidal support the tyre structural components, as disclosed in the European patent EP-928,680 mentioned above.

Furthermore, the Applicant has found that marking a tyre structural element by means of an inkjet marking device can be advantageously used also in tyre manufacturing processes wherein, in conjunction with conventional manufacturing process steps according to which the assembling of semi-finished components—which have been prepared separately, before the tyre assembling operation—is carried out, at least one process step involves the manufacturing of a tyre structural element made of elastomer material by laying down at least one elongate element.

In particular, the Applicant has perceived that in said tyre manufacturing processes—i.e. in processes wherein conventional manufacturing steps are combined with at least one step involving the manufacturing of a tyre structural element by laying down at least one elongate element—the step of marking a tyre structural element has to be provided with a high operating flexibility. In fact, since said tyre manufacturing processes are characterized by high production flexibility and can be advantageously used for manufacturing even very small lots of tyres, the Applicant has perceived that also the step of marking has to be carried out by using a marking device which can quickly and simply modify the marking to be imprinted on the tyre structural element.

The Applicant has found that an inkjet marking device is particularly advantageous for carrying out the marking step of said tyre manufacturing processes thanks to the fact that an inkjet marking device is electronically controlled and the set up thereof (e.g. modifications of the writing to be printed out) can be varied in real time as soon as a different lot of tyres is going to be produced.

Preferably, the tyre structural element, which is provided with at least one marking by means of an inkjet marking device in accordance with the present invention, is at least the tread band.

Alternatively, the tyre structural element, which is provided with at least one marking by means of an inkjet marking device in accordance with the present invention, is at least one sidewall.

Alternatively, the tyre structural elements, which are provided with at least one marking by means of an inkjet marking device in accordance with the present invention, are the tread band and at least one sidewall.

Conventionally, an inkjet printing device comprises an ink vessel (e.g. an ink cartridge) and at least one printhead which is provided with a matrix of inkjets, each inkjet having a fine ejection port, e.g. a nozzle, that ejects the ink in the form of tiny liquid droplets.

Generally, means is provided for supplying the ink to the nozzles as well as a plurality of electrically actuated valve means—one for each nozzle—to regulate the ejection of the ink droplets from the respective inkjets.

Preferably, an inkjet printing system is electronically controlled by means of a plurality of controllers, one for each printhead, each controller comprising a microcomputer interconnected with a data bank for processing and storing the data received from a terminal which is operated by the technical staff. Each controller has an output circuit, which is interconnected with the microcomputer thereof and with the respective printhead, which receives from the microcomputer output data and converts the latter into signals suitable for the printhead valve means to actuate the nozzles and to print a desired marking, e.g. an identification code.

In order to obtain markings of high quality by employing such an inkjet print head, it is desirable to keep the rate flow and the ejecting velocity of the ejected liquid droplets as uniform as possible.

Additional features and advantages of the invention will be better apparent from the following description of some preferred embodiments of tyre manufacturing processes according to the present invention, which description is made, by way of non-limiting example, with reference to the attached drawings, wherein:

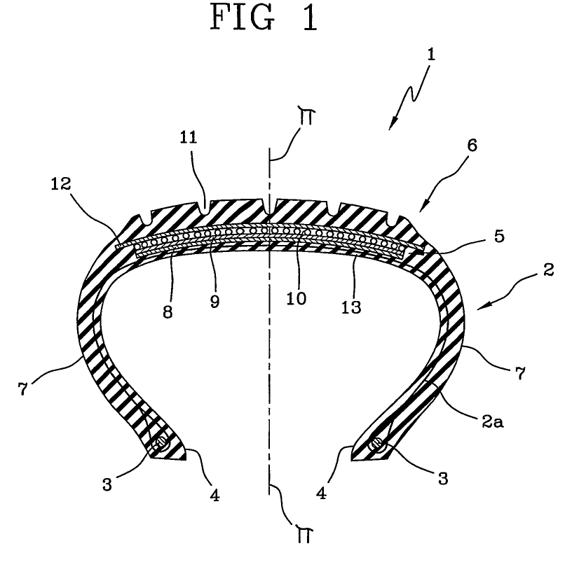

FIG. 1 is a partial cross-section view of a pneumatic tyre obtained with a process according to the present invention;

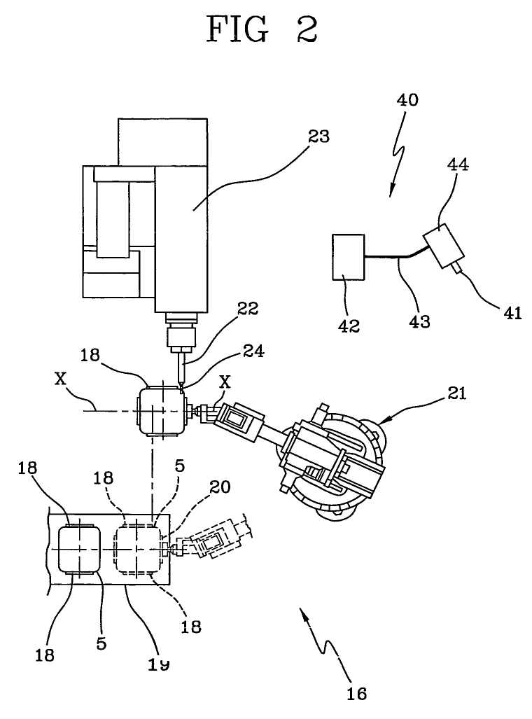

FIG. 2 is a partial schematic plan view of a robotized work station for marking the tread band of a pneumatic tyre in accordance with a process of the present invention;

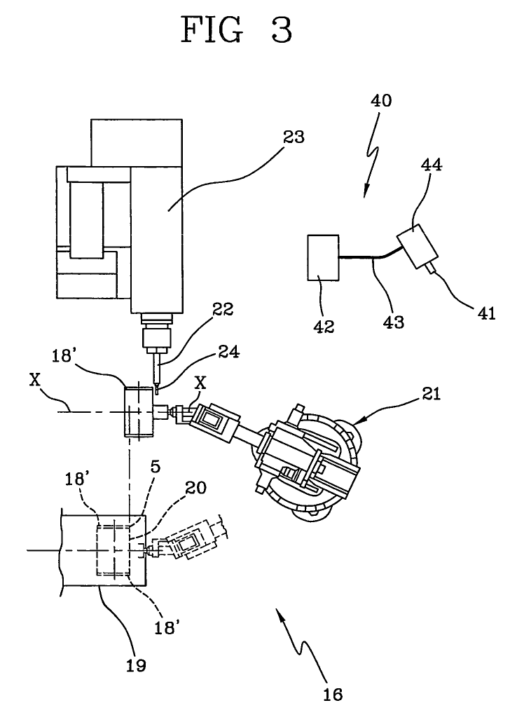

FIG. 3 is a schematic plan view of a robotized work station for marking the tread band of the pneumatic tyre in accordance with a further embodiment of the process shown in FIG. 2;

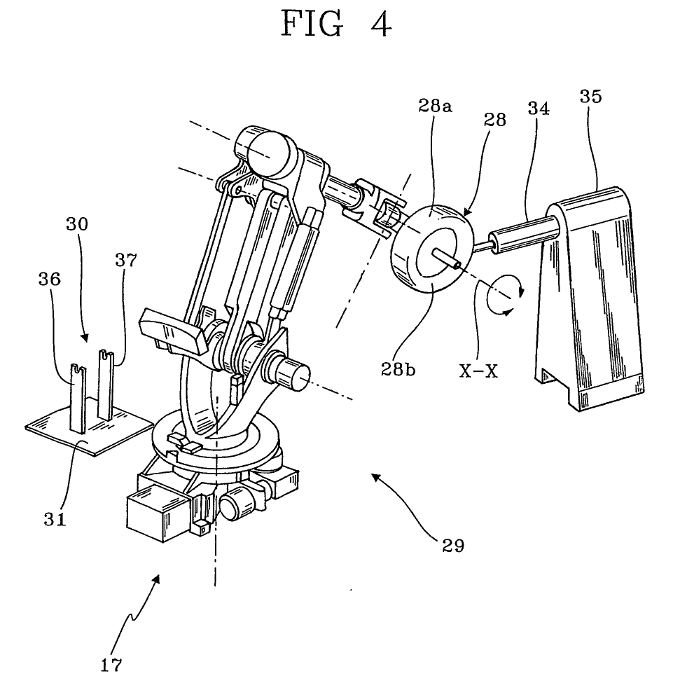

FIG. 4 is a schematic perspective view of a robotized work station for marking the tread band of a pneumatic tyre in accordance with a process of the present invention which makes use of a substantially rigid toroidal support.

FIG. 1 shows a partial cross-section view of a tyre 1 comprising a carcass structure 2 obtained with a conventional tyre manufacturing process. In fact, the carcass structure 2 comprises at least one carcass ply 2a, the opposite side edges of which are externally folded up around respective annular reinforcing structures 3, usually known as bead cores.

Alternatively (said embodiment being not shown), each carcass ply 2a has its ends integrally associated with the bead core 3, as disclosed in the European patent EP-928,680 mentioned above.

The bead core 3 is enclosed in a bead 4 defined along an inner circumferential edge of the pneumatic tyre 1 and at which the pneumatic tyre engages on a rim (not shown) forming part of the wheel of a vehicle.

The tyre 1 comprises a pair of sidewalls 7 which are located in axially opposite positions with respect to the carcass structure 2.

The tyre 1 also comprises a tread band 6 in a position radially external to the carcass structure 2. The tread band 6 is made of an elastomeric material into which, at the end of the curing and moulding steps, a raised pattern is formed for the tyre ground contact. In FIG. 1 the tread band 6 is provided with a plurality of grooves 11 which define a plurality of ribs and blocks of the tyre tread pattern.

The tyre 1 further comprises a reinforcing structure 5, usually known as belt structure, which is positioned between the carcass structure 2 and the tread band 6. Preferably, the belt structure 5 includes at least two radially superposed layers 8, 9 of rubberised fabric provided with reinforcing cords, usually of metal material, disposed parallel to each other in each strip and in crossed relationship with the cords of the adjacent strip, preferably symmetrically disposed with respect to the equatorial plane π-π of the tyre. Preferably, the belt structure 5 further comprises, at a radially external position of said belt layers 8, 9, at least one further layer 10 of textile or metallic cords substantially circumferentially disposed, said cords being spirally and coaxially wound at a radially outer position with respect to the belt layers 8, 9.

In the embodiment shown in FIG. 1, the tyre 1 is further provided with a layer 12 of a suitable elastomeric material which is interposed between the tread band 6 and the belt structure 5. Preferably, the layer 12 has the function of improving the adhesion between the tread band 6 and the belt structure 5.

Finally, in tyres of the tubeless type, i.e. devoid of an air inner bladder, a radially internal elastomeric layer 13, i.e. the liner, is present which has imperviousness features to ensure the tyre air-tightness.

With reference to FIGS. 2, 3 and 4, respective work stations are described, generally indicated with reference sign 16 in FIGS. 2 and 3 and with reference sign 17 in FIG. 4, which are provided for manufacturing the tread band 6 and marking it in accordance with the manufacturing process of the present invention.

In the embodiment illustrated in FIG. 2, a robotized work station 16 is associated to a conventional manufacturing plant for the production of pneumatic tyres, said conventional plant being not shown in details as known per se.

In such a plant, apparatuses—known per se and not shown—are provided for manufacturing the carcass structure 2 and the annular reinforcing structure 3 associated thereto on a supporting element capable to assume a substantially toroidal configuration, such as for example a manufacturing drum 18, as well as for subsequently forming the belt structure 5 in a radially outer position with respect to the carcass structure 2.

The work station 16 comprises a robotized arm 21, preferably of the anthropomorphic type with seven axes, intended to pick up each drum 18 supporting the carcass structure 2, the annular reinforcing structure 3 and the belt structure 5 from a pick up position 20, defined at the end of a conveyor belt 19 or other suitable transporting means, to a delivery position of the tread band 6.

In FIG. 2, the work station 16 further comprises a delivery member 22 of an extruder 23 which provides for a continuous elongate element 24—having a suitable size in cross-section—which is suitable for manufacturing the tyre tread band 6.

With reference to the work station 16 and to FIG. 2, the tyre manufacturing process comprises a plurality of preliminary steps which are carried out upstream of the work station 16. In particular, the carcass structure 2 comprising the annular reinforcing structure 3 and the belt structure 5 are manufactured and shaped on the drum 18 which assumes and then determines a substantially toroidal shape of the pneumatic tyre under construction. Said drum 18 is then transported by the conveyor belt 19 to the pick up position 20.

In a subsequent step, the robotized arm 21 positions the drum 18 in the delivery position defined at the delivery member 22 of the elongate element 24 intended to obtain the tread band 6.

In such a delivery position, the robotized arm 21 rotates the drum 18 about its rotation axis X-X and carries out a relative displacement between the delivery member 22 and the drum 18 by also imparting to the latter a translational movement along a direction substantially parallel to the aforementioned rotation axis X-X.

Concurrently with the rotation and translation movement of the drum 18, the delivery member 22 delivers the elongate element 24 at a radially outer position with respect to the belt layer 5 so as to form the tread band 6, for instance as disclosed in the European patent EP-928,680 or in the patent application WO 03/070454 in the name of the same Applicant.

The rotation and translation movement of the drum 18 is suitably driven in such a way as to carry out the deposition of at least one strip-like elongate element to form a plurality of coils or windings, which are axially overlapped and/or radially superimposed so as to define the tread band 6.

At the end of the deposition step, the tread band 6 of the green tyre is provided with at least one marking by using an inkjet marking device 40.

According to the embodiment shown in FIG. 2, the inkjet marking device 40 comprises a nozzle 41 which is associated to a pressurized vessel 42 through a hose 43. The pressurized vessel 42 contains the ink which is necessary for providing the tread band with at least one marking, said ink being dispensed under pressure by the nozzle 41.

According to the embodiment of FIG. 2, the inkjet marking device 40 is shown to have only one nozzle 41. However, an inkjet marking device generally comprises at least one printhead which is provided with an array of nozzles, the number of which depends also on the kind of marking to be transferred onto the tyre structural element.

Preferably, an inkjet marking device is suitable for simultaneously providing the tyre structural element with different markings, such as an alpha-numeric identification code and at least one coloured circumferential line, the inkjet marking device being provided with a plurality of printheads (each printhead being provided with an array of nozzles).

For instance, a suitable inkjet printer for carrying out the marking step in accordance with the process of the present invention is the Rea-Jet printer, manufactured by REA Elektronik GmbH.

According to the embodiment of FIG. 2, the inkjet marking device 40 further comprises a control panel 44 by means of which the operator performs the desired set up of the marking device.

In more details, in order to perform the marking of the tread band 6, the robotized arm 21 positions the drum 18 in proximity of the inkjet marking device 40. Successively, the robotized arm 21 rotates the drum 18 about its rotation axis X-X and, concurrently with said rotational movement, the inkjet marking device 40 provides the tread band with the desired marking, e.g. a coloured line or an identification code or both.

Alternatively (said embodiment being not shown), at the end of the tread band deposition step, the robotized arm 21 discharges the drum 18—supporting the green tyre—on a conveyor means. Successively, a rotating transferring apparatus, e.g. a manipulator, takes the drum 18 from the conveyor means and positions the drum 18 in proximity of the inkjet marking device 40 so that the step of providing the tyre tread band with a desired marking can be carried out as disclosed herein above.

At the end of the marking step, the manufacturing process according to the present invention can comprise the step of storing the finished green tyre before the moulding and curing steps are performed.

Alternatively, at the end of the marking step, the green tyre supported on the drum 18 is transported—in a way known per se and not shown in the figures—to the subsequent work stations of the plant, e.g. the moulding and curing work stations.

According to a variant of the previous embodiment of the process of the present invention, said embodiment being shown in FIG. 3, a substantially cylindrical auxiliary drum 18′ is used on which the belt structure 5 is assembled. The auxiliary drum 18′ is moved substantially in the same way as the drum 18 previously illustrated.

More precisely, the auxiliary drum 18′ is positioned in proximity of the delivery member 22 of an extruder 23; subsequently, an elongate element 24 of elastomeric material is delivered by the delivery member 22 onto the belt structure 5, preferably carrying out a relative displacement between the delivery member 22 and the auxiliary drum 18′ so as to form the tread band 6.

Subsequently, the auxiliary drum 18′ is positioned in proximity of the inkjet marking device 40 so that a marking is provided to the tyre tread band as disclosed with reference to the embodiment of FIG. 2.

At the end of the deposition of the tread band 6, the belt structure-tread band assembly is associated to the remaining components of the tyre which have been manufactured on a different manufacturing drum. Therefore, the final assembling of the green tyre and the subsequent shaping thereof allow to obtain the finished green tyre which is suitable for being moulded and cured.

These preferred embodiments (shown in FIGS. 2 and 3) of the process according to the invention have an advantageous and effective application when it is desired to exploit a conventional production line, making use of at least one manufacturing drum on which the semi-finished products, which shall constitute the pneumatic tyre, are at least partially formed, said conventional production line being integrated with a final robotized work station for manufacturing the tread band.

In the embodiment illustrated in FIG. 4, a work station intended to manufacture the tread band 6 of the pneumatic tyre 1 is generally indicated with reference sign 17.

The work station 17 is associated to a highly automated plant for manufacturing pneumatic tyres, or for carrying out part of the working operations foreseen in the production cycle of the pneumatic tyres, said plant being not illustrated in details. Further details on such a manufacturing process are, for example, described in the European patent EP-928,680 mentioned above.

According to said process, the manufacturing of the different structural components of the pneumatic tyre 1 are carried out directly on a support 28, substantially toroidal and preferably substantially rigid, having an outer surface 28a, 28b which is substantially shaped according to the inner configuration of the pneumatic tyre.

Within such a plant, robotized work stations (not shown in FIG. 4) are also present for manufacturing on the toroidal support 28 the carcass structure 2 comprising the annular reinforcing structure 3 and for the subsequent formation of the belt structure 5, at a radially outer position with respect to the carcass structure 2.

The work station 17 comprises a robotized arm known per se, generally indicated with reference sign 29 and preferably of the anthropomorphic type with seven axes, intended to pick up each support 28 carrying the carcass structure 2, the annular reinforcing structure 3 and the belt structure 5 from a pick up position 30, defined at the end of two supporting arms 36, 37 of a trestle 31 or other suitable supporting means, to a delivery position of the tread band 6.

More specifically, the delivery position of the tread band 6 is defined at a delivery member 35 of an extruder 34 which provides for at least one continuous elongate element (not shown in FIG. 4) for obtaining the tread band 6.

Further structural and functional details of the robotized arm 29 are described, for example, in the International patent application WO 00/35666 in the name of the same Applicant.

With reference to the work station 17 described above and to FIG. 4, the further preferred embodiment of the process for manufacturing a pneumatic tyre in accordance with the present invention is described herein below.

In details, said process comprises a plurality of preliminary steps which are carried out upstream of the work station 17 by means of a plurality of robotized stations, the latter providing for the manufacturing of the carcass structure 2, the annular reinforcing structure 3 and the belt structure 5 which are successively transported—supported on the toroidal support 28—to the pick up position 30.

In a subsequent step, the robotized arm 29 positions the toroidal support 28 in proximity of the delivery position defined at the delivery member 35 which provides for the elongate element intended to form the tread band 6.

In such a delivery position, the robotized arm 29 rotates the support 28 about its rotation axis X-X and carries out a relative displacement between the delivery member 35 and the support 28 also imparting to the latter a translational movement along a direction substantially parallel to the aforementioned rotation axis X-X.

Simultaneously with the rotation and translation movement of the support 28, the delivery member 35 delivers—by means of the extrusion 34—the elongate element at a radially outer position with respect to the belt layer 5 so as to form the tread band 6.

Preferably, the delivery of the elongate element is carried out by forming a plurality of coils axially arranged side-by-side and/or radially superposed so as to define the tread band 6.

In a subsequent step, the robotized arm 29 positions the support 28 in proximity of an inkjet marking device (not shown in FIG. 4) so that the desired marking is applied onto the tyre tread band according to the steps sequence described with reference to the embodiments of FIGS. 2 and 3.

At the end of the tread band deposition step, the green tyre is completed by transporting the support 28 to the subsequent work stations of the plant, e.g. the moulding and curing work stations.

This different preferred embodiment (shown in FIG. 4) of the process according to the invention has, in particular, an advantageous and effective application when it is desired to use production techniques which allow to minimize, or possibly eliminate, the production and storage of the semi-finished products, for example by adopting process solutions which allow to make the individual components by directly applying them on the pneumatic tyre being manufactured according to a predetermined sequence by means of a plurality of robotized work stations.

The manufacturing process of the present invention offers some major advantages compared to the known art.

First of all, since the inkjet printing system is a non-contact process, the marking step according to the process of the present invention does not cause the elongate element—which form a tyre structural element—to be deformed by pressure, so that the drawbacks mentioned above can be avoided.

Secondly, the inkjet printing system allows that a controlled amount of ink, in the form of fine droplets, reaches the outer surface of the tyre structural element according to a direction which is substantially perpendicular to the outer surface. This aspect, in combination with the fact that the inkjet printing system is a non-contact process, avoids that ink penetration may occur below the windings of the elongate element which form the tyre structural element to be marked. Moreover, the spraying technique and the controlled ink amount which can be transferred onto the tyre structural element, are particularly advantageous for carrying out a discontinuous marking of the tyre, said spraying technique avoiding that ink droplets can be erroneously applied to the tyre.

Furthermore, thanks to the fact that the inkjet printing system is a non-contact process, the marking is effectively and reliably performed notwithstanding irregularities which may be present on the outer surface of the tyre structural element such as, for instance, the overlapping regions of the adjacent windings of the elongate element which form the tyre structural element. Therefore, the process according to the present invention ensures a high quality of the marking, both in case a code or a line have to be provided onto the tyre structural element.

Moreover, the inkjet printing system further contributes to confer high flexibility to the tyre manufacturing process. In fact, thanks to the electronic control of the nozzles of the printheads, it is possible to simply and quickly modify the marking, e.g. the character to be printed out, the writing size and/or format, the predetermined path between two successive markings, the marking colour. These changes can be carried out by modifying the set up of the nozzles or of a part thereof by means of a terminal which is operated by the technical people responsible for carrying out the tyre manufacturing process. Therefore, important structural modifications—e.g. substitution of the printing devices like the marking applicators mentioned above—of the printing system can be avoided.

Moreover, since the marking of the tyre structural element is preferably carried out successively to the deposition step of the elongate element which form the tyre structural element, especially in the case the latter is the tyre tread band, the marking step occurs when the elastomeric material is substantially warm. Said aspect is particularly advantageous for the reason that the heat possessed by the elastomeric material contributes in evaporating the ink solvent so that the ink can strongly adhere to the elastomeric material.

1-28. (canceled)

29. A process for manufacturing a tyre comprising the steps of:
providing a carcass structure having at least one carcass ply associated with at least one annular reinforcing structure;
providing at least one structural element of a green tyre by laying down at least one elongate element made of crude elastomer material in a position radially external to said carcass structure;
providing said at least one structural element of the green tyre with at least one marking by means of an inkjet marking device;
introducing the green tyre into a moulding cavity; and
curing the green tyre.

30. The process according to claim 29, wherein said at least one structural element is a tyre tread band.

31. The process according to claim 29, wherein said at least one structural element is a tyre sidewall.

32. The process according to claim 29, wherein said at least one structural element is a tyre tread band and a tyre sidewall.

33. The process according to claim 29, further comprising the step of providing a belt structure in a position radially external to said carcass structure.

34. The process according to claim 29, wherein the step of providing at least one structural element is carried out by winding at least one elongate element.

35. The process according to claim 34, wherein the step of winding comprises the step of forming a plurality of coils axially arranged side-by-side and/or radially superposed.

36. The process according to claim 29, wherein the step of providing the carcass structure is carried out on a manufacturing drum.

37. The process according to claim 29, wherein the step of providing the belt structure is carried out on a manufacturing drum or on an auxiliary drum.

38. The process according to claim 36 or 37, further comprising the step of positioning said drum in proximity of a delivery member.

39. The process according to claim 38, further comprising the step of delivering the at least one elongate element by means of said delivery member.

40. The process according to claim 39, wherein the step of delivering is performed while carrying out a relative displacement between the delivery member and the drum.

41. The process according to claim 39, wherein the step of delivering is performed while rotating the drum about its rotation axis.

42. The process according to claim 40, wherein the relative displacement between the delivery member and the drum is carried out by imparting to the drum a translational movement along a direction substantially parallel to its rotation axis.

43. The process according to claim 29, further comprising the step of positioning a manufacturing drum or an auxiliary drum in proximity of the inkjet marking device.

44. The process according to claim 29, wherein the step of providing said at least one structural element with at least one marking is performed while rotating a manufacturing drum or an auxiliary drum about its rotation axis.

45. The process according to claim 29, wherein the step of providing the carcass structure comprises the steps of producing and assembling the carcass structure on a toroidal support.

46. The process according to claim 33, wherein the step of providing the belt structure comprises the steps of producing and assembling the belt structure on a toroidal support.

47. The process according to claim 45 or 46, wherein the toroidal support is substantially rigid.

48. The process according to claim 45 or 46, further comprising the step of positioning said toroidal support in proximity of a delivery member.

49. The process according to claim 48, further comprising the step of delivering the at least one elongate element by means of said delivery member.

50. The process according to claim 49, wherein the step of delivering is performed while carrying out a relative displacement between the delivery member and the toroidal support.

51. The process according to claim 49, wherein the step of delivering is performed while rotating the toroidal support about its rotation axis.

52. The process according to claim 50, wherein the relative displacement between the delivery member and toroidal support is carried out by imparting to the toroidal support a translational movement along a direction substantially parallel to its rotation axis.

53. The process according to claim 45, further comprising the step of positioning the toroidal support in proximity of the inkjet marking device.

54. The process according to claim 45, wherein in the step of providing said at least one structural element with at least one marking is performed while rotating the toroidal support about its rotation axis.

55. The process according to claim 29, wherein the inkjet marking device comprises at least one printhead.

56. The process according to claim 55, wherein the printhead is provided with at least one nozzle.
